(19) United States
(12) Patent Application Publication
(10) Pub. No.: US 2006/0275020 A1
(43) Pub. Date: Dec. 7, 2006

(54) Method and apparatus of video recording and output system

(76) Inventor: Chih-Ta Star Sung, Glonn (DE)

Correspondence Address: Chih-Ta Star SUNG, RM. 308, BLD. 52, NO. 195. CHUNG HSING RD.,, SEC. 4. CHU TUNG TOWNSHIP,, HSINCHU COUNTY, 310, TW

(21) Appl. No.: 11/141,180

(22) Filed: Jun. 1, 2005

(51) Int. Cl. H04N 5/91; H04N 7/173; H04N 7/00

(52) U.S. Cl. 386/46; 725/134

(57) ABSTRACT

A video recording and output system applies compression method and apparatus to plurality of images. The majority pixels of video stream which have been compressed and saved into a storage device have no data loss compared to the original raw image data is compressed by a method so named as “lossless” compression algorithm. When outputting the compressed image, a decompression engine is to reconstruct the compressed image into the raw image firstly and output to a display device. Another mechanism of outputting the decompressed image of raw image is to re-compress it into another image format with a certain amount of pixels having data loss compared to original image.

### BACKGROUND OF THE INVENTION

1. Field of Invention

The present invention relates to video data recording and output, and more particularly relates to the video data compression/decompression to reduce the data amount to be stored into the storage media within a video recording and playback device.

2. Description of Related Art

With top image quality in capturing, processing and display, the semiconductor image sensor including CCD, the Charge Coupled Device has since late year 1970 become adopted in video recording system as the image capturing device in so named “Camcorder” recording motion pictures. Due to the consideration of cost, in the past decades, the captured video data within a recording system have been stored into magnetic tapes. Some popular storage media is the 8 mm magnetic tape which can store up to ˜2 hours of VGA (640×480 pixels) resolution with 30 fps, frame per second resolution video. This represent a total of 100 GB (Giga Byte) digitized image data can be stored into a 2 hours tape.

Since the popularity of the technology in digital video compression and VLSI designs, some video recorders are adopting video compression technology like MPEG1, MPEG2, MPEG4 and H.264 as the video format in video data compression and storage. The compression rate of the popular MPEG video ranges from 50× to 150× which means a data reduction rate of 50× to 150× and implies that a 10 GB HD can store more than 6 hours of video with VGA (640×480 pixels resolution) and more than 20 hours of VGA (352×288 pixels resolution). The high compression rate of MPEG video also enables the digital recording system to store video into storage device other than magnetic tape including the so named micro “Hard drive (HD)”, or semiconductor memories like “flash EPROM”. HD and flash memory have benefit of small size. Even the cost is still higher, a micro HD and flash memory have become more popular in storing compressed video data with main advantage of small size with fast accessing time.

The advantage of video compression technology like MPEG is the high compression rate ranging from 50× to 150× which reduces the requirement of storage device and time of transmission. The disadvantage of the MPEG video compression technology is the loss of image information since most video compression including MPEG are lossy algorithm which have more or less image data loss to a certain of degree. When recovering from the compressed video sequence, the video scaling mechanism become even complex in achieving good image quality which most likely needs more frames of previous pictures to predict the missing image lost in video compression procedures. Procedures of scaling and playback the compressed video data of lossy algorithm including MPEG is very costly, slow and can not recover back to the quality of original image.

This invention of the apparatus of video recording and playback system provides new video data compression mechanism for video recording and playback system which provides lossless video data reduction or minimizes the rate of data loss and achieves top quality and simplicity in encoding and decoding the video data.

### SUMMARY OF THE INVENTION

The present invention is related to an apparatus of video recording and playback system, which plays an important role in video data reduction, specifically in compressing the video data before saving it to the storage device. The present invention significantly reduces the required storage device density and maintains the original image quality or minimized loss rate of the image data.
The present invention of the apparatus of video recording and playback system applies a lossless video compression mechanism to significantly reduce the density, bandwidth requirement and power consumption of the storage device.
The present invention of the apparatus of video recording and playback system applies another near lossless video compression mechanism to significantly reduce the density, bandwidth requirement and power consumption of the storage device.
According to an embodiment of the present invention of the lossless or near lossless video compression, a motion estimation procedure is applied to identify the best match block of pixels.
According to an embodiment of the present invention, the difference of block pixels between the target block and the best match block are coded by a variable length code which is a lossless algorithm.
According to another embodiment of the present invention, the difference of block pixels between the target block and the best match block are coded by a lossy approach including bit truncation of a certain of pixels.
According to another embodiment of the present invention, the difference of block pixels between the target block and the best match block are coded by a mixture of lossless and lossy approach for a certain of pixels.
According to another embodiment of the present invention, when exporting the compression video data, the compressed video data is read from the storage device and output to the external media.
According to another embodiment of the present invention, when exporting the compression video data, a decoder is applied to recover the video data to be original format of digitized image data.
According to another embodiment of the present invention, when exporting the compression video data, a decoder is applied to trans-code the compressed video data to be a target video format including bit map, RGB format, an MPEG, the ISO video compression standard or theH.264 format, an ITU video compression standard.

It is to be understood that both the foregoing general description and the following detailed description are by examples, and are intended to provide further explanation of the invention as claimed.

### BRIEF DESCRIPTION OF THE DRAWINGS

FIG. 1 illustrates a prior art of block diagram of a lossless video recording and output system.

FIG. 2 illustrates a prior art of block diagram of a video recording and output system with lossy video compression algorithm.

FIG. 3 depicts a block diagram of the present invention of the video recording and output system with a lossless video compression codec.

FIG. 4 depicts a block diagram of the present invention of the video recording and output system with a lossless or near lossless video compression codec and a transcoder which converts the video to other video format.

FIG. 5 illustrates the block diagram of the mechanism of the best matching block searching.

FIG. 6 illustrates the block diagram of the mechanism of the MPEG video data coding.

FIG. 7 illustrates the block diagram of the procedure of coding the video data of present invention.

### DESCRIPTION OF THE PREFERRED EMBODIMENTS

In the past decades since the new venture of the semiconductor CCD image capturing sensor which provides good quality in capturing picture, some still image and motion video related applications have boomed the market. Even the image quality or named the “Dynamic range” is still far behind CCD sensor, the CMOS image sensors are invading the image sensor market in the past decade. The applications of the semiconductor image sensor in still image include scanner, digital still camera (DSC), in motion video include video conference, Web (or PC) camera, surveillance system, mobile phone, video recorder . . . . In the video recording applications, the most popular products include the camcorder, DSC with motion video capturing function and other video recording devices. In the present invention of the video recording and output system, the apparatus applies to but not limited to above products.

FIG. 1 illustrates a prior art video recording system without applying image compression techniques. This kind of prior art video recording system design is popular in the camcorder. Light 10 of an image shooting through a lens 11 are captured by an image sensor 12 which might be either CCD or CMOS image sensor. After a procedure of image processing 13, which might include color compensation, gamma correction . . . the image is save into a storage device 15 which in camcorder might be an 8 mm tape, hard disk or other media like semiconductor memory. The captured and stored video can be sent out through output buffer 14 and display interface 16 and exported to output device including TV, DVD player, display panel or to other media for possible manipulation. This kind of video recording system is classified into “lossless” image/video recording.

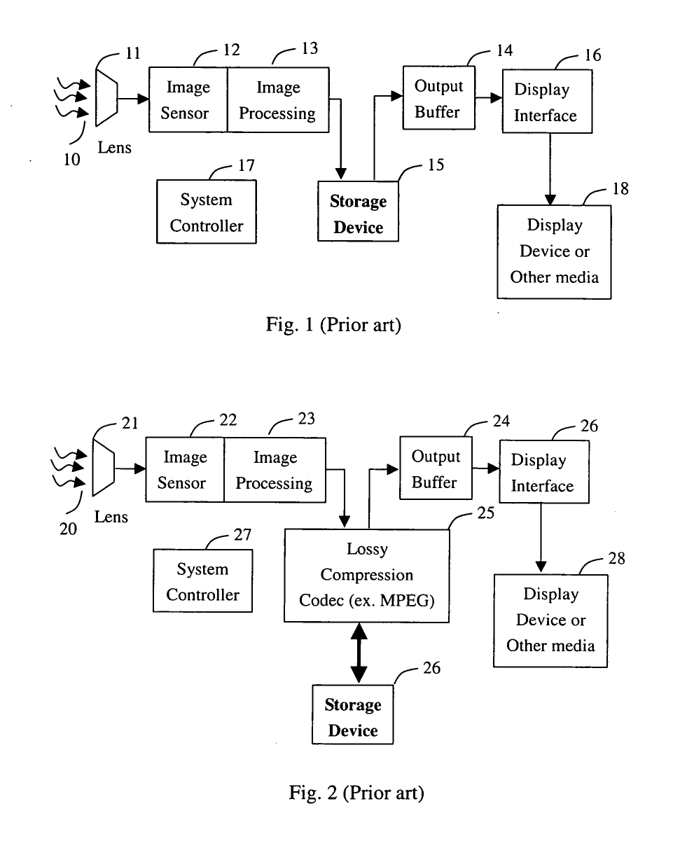

Another alternative of video recording is a “lossy” mechanism as shown in FIG. 2 which has become more popular after MPEG is adopted as a video compression standard and is supported by most computer, DVD player and some portable devices. The main difference between FIG. 1 prior art and the FIG. 2 prior art is that the captured and processed image goes through a procedure of video compression 25. Light 20 of an image shooting through a lens 21 are captured by an image sensor 22 which might be either CCD or CMOS image sensor. After a procedure of image processing 23, the motion video goes through a mechanism of video compression 25 before saving into a storage device 25 which in camcorder might be an 8 mm tape, hard disk or other media like semiconductor memory. During outputting, the saved video stream is decompressed 25 before sending to the output buffer 24 and the display interface unit 26. Some display devices have capability of decompressing the video stream, and the video stream can be directly sent to that device for decompressing and display 28. Some media like PC might have decompression feature and the output video stream is sent to that media 28.

The benefit of FIG. 2 prior art of applying a lossy video compression mechanism is that reduces the amount of video data significantly. Taking MPEG2 as an example, it is common that MPEG2 reaches the compression rate of 100 times, which means a video stream of 2 hours VGA (640×480 pixels per picture) resolution of 30 frame per second video (65 Giga Byte) data can be reduced to be 500-600 Mega Byte (500 MB-600 MB). With 100× compression rate, even the MPEG2 video looks not very good quality, it saves data amount significantly and makes a storage device record 100× longer time of compressed video stream compared to the prior art of not compression mechanism in FIG. 1. The lossy vide compression like MPEG2 with acceptable good image quality has an average of mean absolute error (MAE) of 2, ˜1% error for most blocks of pixels, which stands for 37 dB compared to the original video data.

This invention of the video recording and output system applies compression technology to reduce the amount of video data with top image quality. The main differentiation of this invention to the prior art in FIG. 2 is that the present invention applies video compression technique which even reaches lossless video quality or significantly reduces the mean absolute error (MAE) rate down to well below 0.1% or instead of 1% in MPEG video compression. When determining lossless image quality of the video compression, the present invention generates the video data with all pixels having no error compared to the original video stream. When selecting a “near lossless” mechanism, most pixels in the video stream will still have no error compared to the original video stream. Only a few pixels for example said less than 30% of pixels have a little error compared to the original video stream.

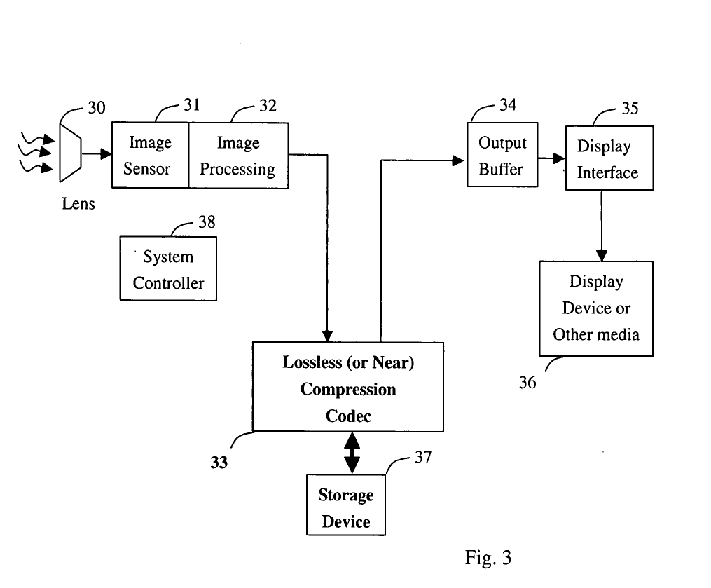

FIG. 3 illustrates the block diagram of the present invention of the video recording and output system. Compared to the two above prior art video recording and output systems, the present invention applies “lossless” or “Near lossless” compression mechanism to significantly reduce the amount of video data and can still obtain top image quality.

The image continuously shooting through a lens 30 are captured by an image sensor 31 which might be made by either the CCD or CMOS image sensor array. After a procedure of image processing 32, which might include color compensation, gamma correction . . . the image data of the continuous motion video goes through a procedure of “lossless” or “Near lossless” compression 33 before saving into a storage device 37 which might be a magnetic tape, hard disk or other media like semiconductor memory. The captured and stored video can be sent out through output buffer 34 and display interface 35 and exported to output device including but not limited to PC, TV, DVD player, display panel 36 or to other media for possible manipulation. This kind of video recording with lossless or near lossless compression algorithm has high amount of pixels having no error compared to the original pixels of the video data stream. A system controller 38 is implemented to control the image data flow and all mechanism video compression, recording and output. If lossless compression is decided, all pixels of the compressed video stream can be reconstructed to be exactly the same like the original video stream without any error of all pixels.

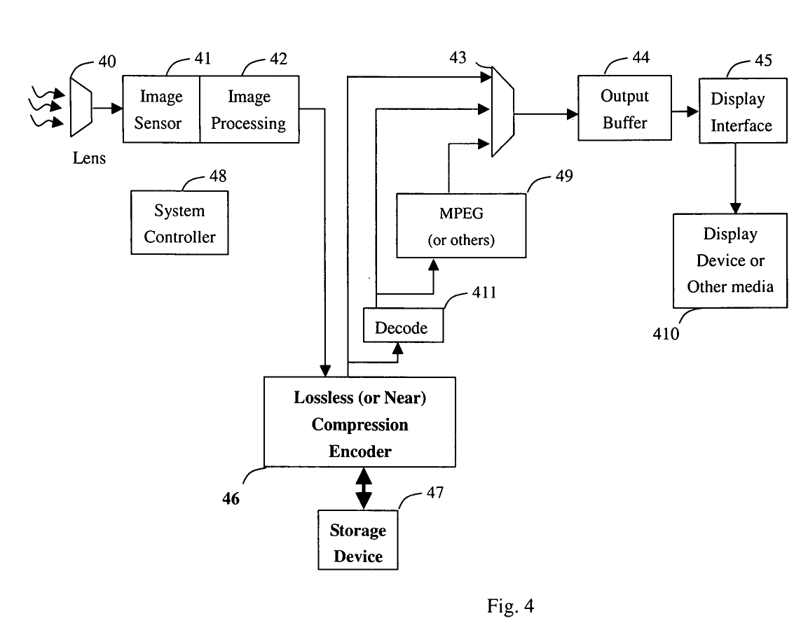

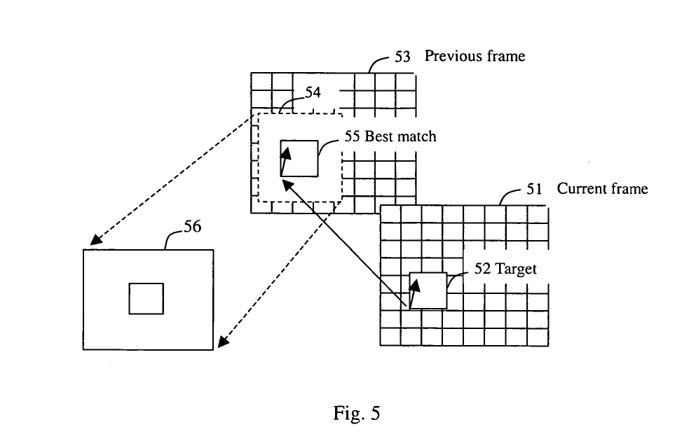

Since MPEG is a popular international video compression standard, another optional design inserting an MPEG encoder to convert the lossless or near lossless video data into MPEG compatible video stream as shown in FIG. 4 The captured and compressed video data which is stored in storage device 47 is decoded through a video decoder 411 before sending to an MPEG video compression engine 49. A MUX 43 select one of the three video data formats which are lossless or near lossless compressed video stream, a video stream data decoded from the storage device 47 with lossless or near lossless compression algorithm and a compressed MPEG video stream.

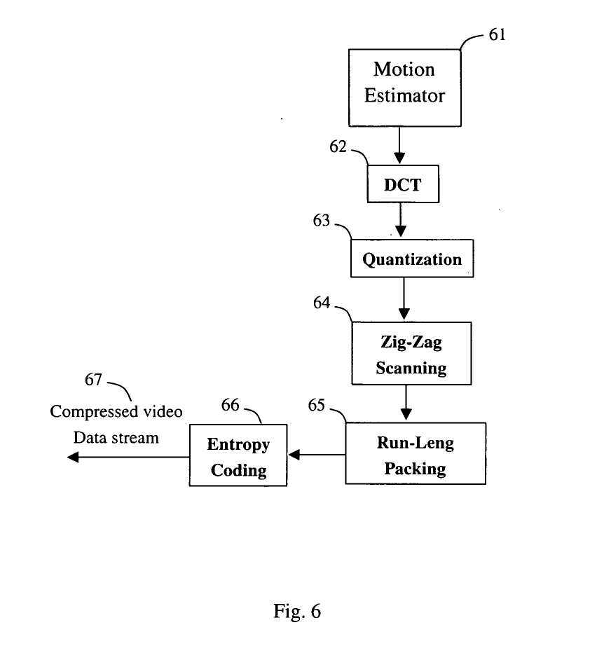

FIG. 6 shows a prior art block diagram of the MPEG video compression, which is prevailingly popular motion video compression standard adopted by video compression IC, software and system suppliers. The motion estimator 61 searches for the best matching block of pixels from previous picture and generate the difference pixels values between the target block and the best matching block of pixels and feeds into the DCT, the Discrete Cosine Transform block 62, before the Quantization step 63. The DCT transfers time domain data into frequency domain and concentrates the information into “DCT Coefficients” in the left top corner. The farer from the left top corner, the higher frequency coefficients will be and less important the coefficient can represent the information. The quantization table is a matrix of 64 parameters with larger step in farer away from the left top is used to quantize DCT coefficients. After quantization, most likely more than half DCT coefficients are rounded to “0s” and thoses non-zero coefficients become smaller altitude are scanned by an order of zig-zag 64 from lower frequency to higher frequency coefficients. A Run-Length packing 65 step is to packing the scanned DCT coefficients with counting Run/Number of “0s” and the followed number of non-zero coefficient. A lossless entropy coding 66 method is applied to represent the zig-zag scanned and “Run-level” packed “patterns” according to the occurrence will later be assigned code with variable length 66 to represent it. The entropy coding is a method using shortest code to represent the most frequent occurrence. In MPEG video compression, the most frequent occurrence is “End of Block” which means no more non-zero DCT coefficient and is assigned “00” to represent it hence significantly reduce the data amount.

DCT coupled with quantization are 2 mains steps prepared for applying the entropy coding to reduce the data amount which makes >100× compression rate possible. Almost all MPEG video streams have more than 70% of pixels encompassed more or less data loss compared to the original raw video data that is caused by the step of “quantization” procedure. Besides precision issue, quantization is the only step causing data loss in video compression.

The present invention of video compression goes through different algorithm of adopting non DCT and non quantization methods to achieve higher image quality. In lossless or near lossless video data compression of this present invention of video compression, a block based “best matching algorithm” is applied to identify the location of block of pixels of previous picture which has highest similarity as shown in FIG. 5. The higher the similarity of a picture within a video stream, the higher compression rate one can obtain.

In most video compression systems, a video stream is comprised of continuous frames. The current frame is divided into a certain amount of blocks comprising pixels ranging from 4×4, 8×8, 16×16 to even 64×64 pixels. The motion estimation of searching for the best matching block within a frame consumes high computing power. In the search for the best match block 55 in previous picture 53, a searching range 54, for example ±16 pixels in both X- and Y-axis in previous frame. The mean absolute difference, MAD or sum of absolute difference, SAD as shown below, is calculated for each position of a block within the predetermined searching range, for example, a ±16 pixels of

$$SAD ( x , y ) = {\sum }_{i = 0}^{15} {\sum }_{j = 0}^{15} \vert {V}_{n} ( x + i , y + j ) - {V}_{m} ( x + dx + i , y + dy + j ) \vert$$

$$MAD ( x , y ) = \frac{1}{256} {\sum }_{i = 0}^{15} {\sum }_{j = 0}^{15} \vert {V}_{n} ( x + i , y + j ) - {V}_{m} ( x + dx + i , y + dy + j ) \vert$$

the X-axis and Y-axis. In above MAD and SAD equations, the Vn and Vm stand for the 16×16 pixel array, i and j stand for the 16 pixels of the X-axis and Y-axis separately, while the dx and dy are the change of position of the block.

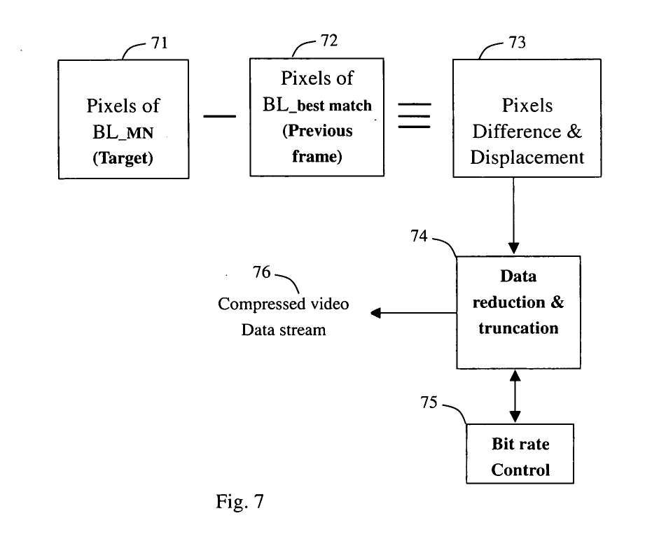

After the best matched block is identified, every pixel within the target block 52 of the current frame 51 is subtracted from the corresponding pixels of the best matched block of previous frame. FIG. 7 shows the conceptual diagram of the next step of video coding after the best matched block is identified. The pixel difference plane 73 is formed by subtracting the targeted block pixels 71, BL_MN of the current frame from the block pixels of the best matched 72 in previous frame. Afterward, the pixel differences are coded by using a data reduction coding method 64 which is a lossless coding. In case of pursuing higher compression rate or limited density of storage device, a certain amount of pixels might not be coded by a lossless coding algorithm, a lossy method of truncation is applied to some pixels monitoring through a bit rate controller 65. The output of the lossless data compression (or lossy bit truncation) 66 is a final compressed video stream. When truncation is decided, only a certain amount of blocks within a video stream have a certain not all pixel differences are truncated which maintains high image quality close to the original image data.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A digital video recording apparatus for manipulating at least one received raw image to be stored in a storage and to be output to a display device, comprising:
an image compression apparatus which reduces the image data of at least one raw image with majority of pixels having no difference comparing to the original pixels;
a storage device saves at least one compressed image before outputting to another device;
an image decompression apparatus which recovers the compression image into another image format; and
an output device connecting between an image decompression device and another device for display or connecting to another output apparatus.

2. The apparatus of claim 1, wherein the raw image has a plurality of lines, each line has a plurality of blocks, and each block has a plurality of pixels; and the image compression codec device performs a data reduction on the raw image to generate an intermediate data that has less data amount than the raw image.

3. The apparatus of claim 1, wherein the storage device is comprised of a magnetic device.

4. The apparatus of claim 1, wherein the storage device is comprised of a semiconductor memory device.

5. The apparatus of claim 1, wherein the output device is comprised of a display device with LCD display panel.

6. The apparatus of claim 1, wherein the output device is comprised of a display device with LCD display device, for example, a digital TV.

7. The apparatus of claim 1, wherein in the image decompression device reconstructs the compressed image data with majority of pixels recovered to be original image formats;

8. A method of compressing the plurality of image with majority pixels having no difference comparing to the original pixels, comprising
searching for the best matching block for each block pixels from at least one nearest image to the targeted image;
coding the value of displacement of the best matching block of at least one nearest image and the targeted block pixels;
a bit rate control procedure which counts the data of compressed image and determines the compression ratio to be assigned to each image of the video sequence; and
coding the difference between the best matching blocks of at least one nearest image and the targeted block pixels.

9. The method of claim 8, wherein the best matching algorithm takes the block of a location with minimum value of pixel differential sum within a predetermined searching area as the best matching block.

10. The apparatus of claim 8, wherein in coding the difference of the best matching block of at least one nearest image and the targeted block pixels, most pixels have no difference compared to the original pixels;

11. The apparatus of claim 8, wherein in coding the difference of the best matching block of at least one nearest image and the targeted block pixels, a certain amount of pixels have some degree of data loss compared to the original pixels with bit rate controlled by another device;

12. The apparatus of claim 8, wherein in coding the displacement of the best matching block of at least one nearest image and the targeted block pixels, the value of X-axis stands for pixel number of movement in X-direction and the value of Y-axis stands for pixel number of movement in Y-direction;

13. A method of recovering at least one compressed images, comprising reconstructing the compressed image into the original raw image format with majority pixels having no difference compared to the original pixels;
compressing the raw image data to another image compression format; and
outputting the compressed image data stream into another display or storage device.

14. The apparatus of claim 13, wherein in reconstructing the compressed the image pixels, an Red,Green,Blue format is a targeted raw image data.

15. The apparatus of claim 13, wherein in reconstructing the compressed the image pixels, an Y/U/V or Y/Cb/Cr format is a targeted raw image data.

16. The apparatus of claim 13, wherein in compressing the reconstructed image pixels, a certain amount of pixels have difference compare to the original pixels.
